(19) United States
(12) Patent Application Publication
(10) Pub. No.: US 2017/0257450 A1
(43) Pub. Date: Sep. 7, 2017

(54) Intelligent System of Information Broker under a Data and Energy Storage Internet Infrastructure

(71) Applicant: Futurewei Technologies, Inc., Plano, TX (US)

(72) Inventors: Lei Rao, Mountain View, CA (US); Jian Li, Austin, TX (US); Jiafeng Zhu, Pleasanton, CA (US); Ron-Chung Hu, Palo Alto, CA (US)

(21) Appl. No.: 15/057,665

(22) Filed: Mar. 1, 2016

(51) Int. Cl. H04L 29/08; H04W 84/12

(52) U.S. Cl. CPC H04L 67/2809; H04L 67/22; H04L 67/24; H04W 84/12

(57) ABSTRACT

A method implemented in a network element (NE) configured to operate as an Ensemble Information Broker (EIB) within a data and energy storage internet architecture, the method comprising collecting device data, human presence data, and human activity data; determining predicted human behaviors for the user; determining a predicted energy metric for the smart system during a future time slot; calibrating weighted objective metrics of an operating status of the devices, a human comfort level, and a human productivity level according to the predicted human behaviors and user defined preference levels defined for the smart system; generating a set of control commands for the devices within the smart system by executing the dynamic human-centric Objective Function on the predicted energy metric; and transmitting, via a transmitter, the set of control commands to corresponding devices within the smart system.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Intelligent control is important to managing computing systems and networks. Analytics and feedback may be employed to achieve multiple objectives by optimal scheduling and resource allocation, such as adjusting scheduling priorities, memory allocations, and network bandwidth allocations. Control theory encompasses a large body of practical, system-control-design principles and provides a systematic approach to designing closed loop systems that are stable in that they avoid wild oscillations, are accurate in that they achieve the desired outputs, and settle quickly to steady state values. Control theory is a branch of theoretical and applied mathematics and is employed in the design of many aspects of computing. Additionally, control theory is employed to analyze and design feedback loops in mechanical, electrical, aeronautical, and other engineering disciplines. As such, control theory has had a profound impact on the design and development of a large number of systems and technologies, from airplanes, spacecraft, and other vehicle and transportation systems to computer systems, industrial manufacturing and operations facilities, machine tools, process machinery, and consumer devices.

Together with inputs from human-machine interfaces, intelligent controls can analyze human preferences and behaviors to provide solutions tailored to each individual. Often an intelligent controller is tasked with controlling a single device or system under stringent constraints to achieve conflicting goals. Designers, manufacturers, and users of intelligent controls have been seeking solutions that effectively control systems while also coordinating with each other to enable better resource sharing and coordination.

### SUMMARY

In one embodiment, the disclosure includes a network element (NE) configured to operate as an Ensemble Information Broker (EIB) within a distributed data and energy storage internet architecture, the NE comprising a receiver configured to collect device data regarding a flow of energy during a time slot through a plurality of devices within a smart system associated with the NE; collect a presence of a user within the smart system during the time slot as human presence data; and collect human activity data regarding user inputs to the devices and user interaction with the devices during the time slot; a processor coupled to the receiver and configured to preform a human behavior analysis of the human activity data and the human presence data to determine temporal human behaviors for the user; determine a projected energy consumption and a projected energy generation for the devices during a future time slot based on the device data and the temporal human behaviors for the user; determine a projected energy metric for the smart system during the future time slot based on a difference between the projected energy consumption and the projected energy generation of the smart system during the future time slot; calibrate weighted objective metrics of an operating status of the devices, a human comfort level, and a human productivity level according to the temporal human behaviors and user defined preference levels defined for the smart system, wherein the weighted objective metrics are included in a dynamic human-centric Objective Function; execute the dynamic human-centric Objective Function on the projected energy metric to generated a result; and generate a set of control commands for the future time slot for the devices according to the result; and a transmitter coupled to the processor and configured to transmit the set of control commands to corresponding devices within the smart system. In some embodiments, the disclosure also includes wherein the dynamic human-centric Objective Function comprises a human-centric multimodal representation of a weighted sum of an energy Cost Function and a user Productivity Function, wherein the energy Cost Function is a representation of an operating status of the devices, and wherein the user Productivity Function is a representation of a human comfort level and a human productivity level within the smart system and comprises a noise function, a cool function, a warm function, a fresh function, and a humidity function each regarding a corresponding operating status of the devices and/or wherein the control commands are for future configuration updates to the devices and/or wherein the processor is further configured to generate a request for energy resource when the projected energy metric indicates a shortage of energy for the smart system during the future time slot, and where the transmitter is further configured to transmit the request to an external NE configured to operate as an external EIB in the distributed data and energy storage internet architecture and/or wherein the processor is further configured to generate a message indicating a surplus of energy when the projected energy metric indicates a surplus of energy for the smart system during the future time slot, and where the transmitter is further configured to transmit the message to an external NE configured to operate as an external EIB in the distributed data and energy storage internet architecture and/or wherein the processor is further configured to generate an alert when a maximum of a data to energy consumption ratio exceeds a threshold based on an adaptive threshold mechanism and/or wherein the receiver is further configured to receive a request to update the threshold based on the alert, wherein the processor is further configured to update the threshold to a current maximum of data to energy consumption ratio and/or wherein the device data includes an amount of energy consumed by the devices during the time slot and an amount of energy generated by the devices during the time slot and/or wherein the dynamic human-centric Objective Function provides a mechanism for a reduction of energy cost within the smart system and an optimization of a productivity of user devices that interact with the smart system and/or wherein the weighted objective metrics are updated by weighting the Objective Function according to user preferences received from a user interface coupled to the NE and within the smart system.

In another embodiment, the disclosure includes a computer program product comprising computer executable instructions stored on a non-transitory computer readable medium such that when executed by a processor cause a network element (NE) configured to operate as an Ensemble Information Broker (EIB) within a distributed data and energy storage internet architecture to collect device data regarding a flow of energy during a time slot through a plurality of devices within a smart system associated with the NE and data generated by the devices related to the flow of energy during the time slot, human presence data regarding a presence of a user within the smart system during the time slot; and human activity data regarding user interaction with the devices during the time slot; determine predicted human behaviors for the user based a human behavior analysis of the human activity data and the human presence data; update an energy data consumption pattern with the device data, wherein the energy data consumption pattern is an internal model that contains historical data regarding an amount of energy consumed and data generated regarding the energy consumed by the devices; determine a predicted energy consumption and a predicted energy generation of the smart system during a future time slot through an application of a charge model associated with the devices to the energy data consumption pattern and the predicted human behaviors; determine a predicted energy metric for the smart system during the future time slot based on a difference between the predicted energy consumption and the predicted energy generation of the smart system during the future time slot; generate a request for energy resources during the future time slot when the predicted energy metric indicates a shortage of energy for the smart system during the future time slot; and transmit, via a transmitter, the request to an external NE configured to operate as an external EIB in the distributed data and energy storage internet architecture. In some embodiments, the computer program product further comprises sending an alert to a user interface when a maximum value for a data consumption ratio exceeds a threshold, wherein the data consumption ratio is determined based on an Internet providing devices consumption pattern. In some embodiments the disclosure also includes wherein the charge model is represented as x̂(t+1)=xt+ut−qt, wherein xt is an inventory level of an energy storage device at a time t, ut is an amount of energy charged to the energy storage device at the time t, and qt is an amount of energy discharged from the energy storage device at the time t, wherein the energy storage device is included in the plurality of devices within the smart system and/or wherein the human presence data comprise information contained in a calendar associated with a user that interacts with the devices within the smart system and/or wherein the human presence data comprise information indicating an estimated number of connections to a Wi-Fi device within the smart system at given time.

In yet another embodiment, the disclosure includes a method implemented in a network element (NE) configured to operate as an Ensemble Information Broker (EIB) within a data and energy storage internet architecture, the method comprising collecting device data regarding a flow of energy during a time slot through a plurality of devices within a smart system associated with the NE, human presence data regarding a presence of a user within the smart system during the time slot, and human activity data regarding user interaction with the devices during the time slot; determining predicted human behaviors for the user based on a human behavior analysis of the human activity data and the human presence data; determining a predicted energy metric for the smart system during a future time slot based on a difference between a predicted energy consumption and a predicted energy generation of the smart system during the future time slot determined according to an analysis of the device data and the predicted human behaviors for the user; calibrating weighted objective metrics of an operating status of the devices, a human comfort level, and a human productivity level according to the predicted human behaviors and user defined preference levels defined for the smart system, wherein the weighted objective metrics are included in a dynamic human-centric Objective Function, and wherein the dynamic human-centric Objective Function comprises a human-centric multimodal representation of a Cost Function and a Productivity Function weighted according to the weighted objective metrics; generating a set of control commands for the devices within the smart system by executing the dynamic human-centric Objective Function on the predicted energy metric; and transmitting, via a transmitter, the set of control commands to corresponding devices within the smart system. In some embodiments the disclosure also includes wherein the Cost Function is a representation of an operating status of the devices, and wherein the weighted Productivity Function is a representation of a human comfort level and a human productivity level within the smart system and/or wherein the dynamic human-centric Objective Function provides a mechanism for a reduction of energy cost within the smart system and an optimization of a productivity of user devices that interact with the smart system. In some embodiments, the method further comprises sending a charge request to external NEs configured to operate as EIBs within the data and energy storage internet architecture when the predicted energy metric indicates a need for energy for the smart system and/or sending a discharge request to external NEs configured to operate as EIBs within the data and energy storage internet architecture when the predicted energy metric indicates a surplus of energy for the smart system.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a smart system deployed within an energy storage internet architecture.

FIG. 2 is a schematic diagram of an embodiment of an NE configured to implement an EIB within a network.

FIG. 3 is a schematic diagram of an embodiment implemented on an EIB configured within a network.

FIG. 4 a schematic diagram of an embodiment of an Energy Supply/Demand Model Predictor (P) component implemented on an EIB.

FIG. 5 is a flowchart of an embodiment implemented in a Human Behavior Analyzer Component of an EIB.

FIG. 6 is a flowchart of an embodiment implemented in a Data and Energy Flow Analyzer Component an EIB when an input is received by the Data and Energy Flow Analyzer Component.

FIG. 7 is a flowchart of an embodiment implemented by a Predictor Component of an EIB when an input is received by the Predictor Component.

FIG. 8 is a flowchart of an embodiment implemented on an EIB when input data is received or sent to an external EIB connected to the EIB through an external gateway.

FIG. 9 a schematic diagram of an embodiment of a Costs-Aware Workload Controller/Scheduler (C) Component implemented on an EIB.

FIG. 10 is a flowchart of an embodiment implemented is on an EIB when input data is received from a user interface.

FIG. 11 is a flowchart of an exemplary embodiment of a method employed by an EIB implemented within a data and energy storage internet architecture to collect energy data and human presence and to generate a set of control commands for devices within an associated smart system EIB through a prediction of future energy consumption requirements and energy generation of the devices within the associated smart system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

One class of feedback control includes intelligent controllers. An intelligent controller may be tasked with controlling systems under various constraints in order to meet control goals. For example, an intelligent controller may control various environmental parameters for a particular environmental system. An intelligent controller may resolve and manage potentially conflicting goals. As such, designers of intelligent controllers may seek control methods and systems that effectively control systems when two or more control goals conflict.

An intelligent controller may only focus on how to reduce energy cost in lieu of how to improve productivity because improving productivity may be more resource intensive than reducing energy cost. However, together with the idea of economy sharing, opportunities exist that may reduce energy cost while at the same time improve productivity and efficiency. For example, control decisions for multiple devices may be correlated thus individual control of each device may lead to sub-optimal results. In an embodiment, an energy solution may employ Google® Nest to leverage machine-learning algorithms. However, Google® Nest provides control for only a single device (e.g. heating, ventilating, and air conditioning (HVAC)). Additionally, Google® Nest fails to leverage communication among intelligent controllers to achieve better resource sharing and coordination.

An intelligent controller may be designed to output control signals to various dynamical components of a system based on a control model and sensor feedback from the system. Such systems may exhibit a predetermined behavior or mode of operation. The control components of such systems are therefore designed to ensure that the predetermined system behavior transpires under normal operational conditions. In certain cases, there may be various different modes of operation for a system, and the control components of the system may therefore select a current mode of operation for the system and control the system to conform to the selected mode of operation.

Disclosed herein is a data and energy storage internet architecture comprising distributed EIBs (e.g., intelligent controllers) that are configured to monitor and control devices within an associated smart system or smart network as well as communicate among one another. The data and energy storage internet provides a mechanism to achieve the dual objectives of energy cost efficiency and increased productivity for users interacting with devices controlled within the data and energy storage internet while meeting service level agreements (SLAs) and Quality of Service (QoS) requirements established for the data and energy storage internet. In an embodiment, EIBs within a data and energy storage internet architecture communicate with one another in a peer-to-peer manner (e.g., by employing peer-to-peer communication protocols). The peer-to-peer communication between EIBs allows each EIB within the data and energy storage internet to send and receive requests to trade information and energy resources through a network directly to/from the other EIBs within the data and energy storage internet.

EIBs within a data and energy storage internet architecture employ intelligent information and resource sharing schemes in order to achieve the above stated system objectives. Each EIB and the controlled consuming, producing, and storing (e.g., battery, data storage) devices form a smart system or smart network. In various embodiments, an EIB functions as a smart controller over the controlled devices within an associated smart system. In an embodiment, the EIB comprises an analytical model and predictor and a costs-aware workload controller/scheduler.

EIBs and associated smart systems may be deployed for offices, homes, large enterprises, and other applicable environments. In an embodiment, a device may be configured to function as an EIB to store device data regarding a flow of energy through the devices within an associated smart system and data generated by the devices regarding the flow of energy. The EIB may also be configured to collect human presence data regarding the presence of a user(s) measured for a particular time period and human activities data regarding interactions with the devices in an associated smart system (e.g., a time of day and/or a number of hours a user has interacted with the devices in the smart system) and/or user inputs, preferences, or configurations to the devices/smart system. The EIB analyzes and controls the devices within an associated smart system by employing machine learning and model-based predictive control techniques. For example, an EIB may control power for an associated device (e.g., whether the device is on or off) and/or a charge (e.g., receiving) and/or discharge (e.g., release) of energy stored on a device (e.g., an energy producing or storage device). In various embodiments, the EIB learns habits of users that interact with the devices within the smart system and may exchange this human presence data and human activities data with other EIBs within the data and energy storage internet. The EIBs may employ the human presence data and human activities data to predict behaviors and to schedule performance and activity for the devices within an associated smart system. Additionally, the EIB may detect anomalies (e.g. energy theft) by monitoring energy and data streaming within the smart system. In various embodiments, an EIB may be configured to contribute to and/or be part of software-defined commodity hardware, which comprises a smart home or a smart city. In an embodiment, an EIB may be implemented as a virtual information broker for smart homes and/or smart offices.

EIBs within the data and energy storage internet may establish “friend” connections between one another. The EIB may trade resources with one another based on a rules set and/or a point-based credit scheme and the established or unestablished friend connections. In an embodiment, the rules set and point-based credit scheme enforce policies which require each EIB to contribute to the energy trading within the data and energy storage internet before placing a discharging request. In an embodiment, the point-based credit scheme employed by an EIB assigns weighted values to external EIBs within the data and energy storage internet that have sent energy to and taken energy from a smart system associated to the EIB. The weighted values factor in the time of day that the energy was taken or received along with an amount of energy taken or received. The point-based credit scheme determines whether an external EIB is qualified to receive energy for the smart system associated to an EIB at a determined request time based on the weighted values and the amount of energy requested. In an embodiment, the point-based credit scheme compares a sent amount of energy or data sent to an external smart system and a received amount of energy or data received from the external smart system and comprises a weight function comprising a weight value determined based on a temporal distance between the specified time and a peak time for energy or data consumption within an associated smart system assigned to the EIB.

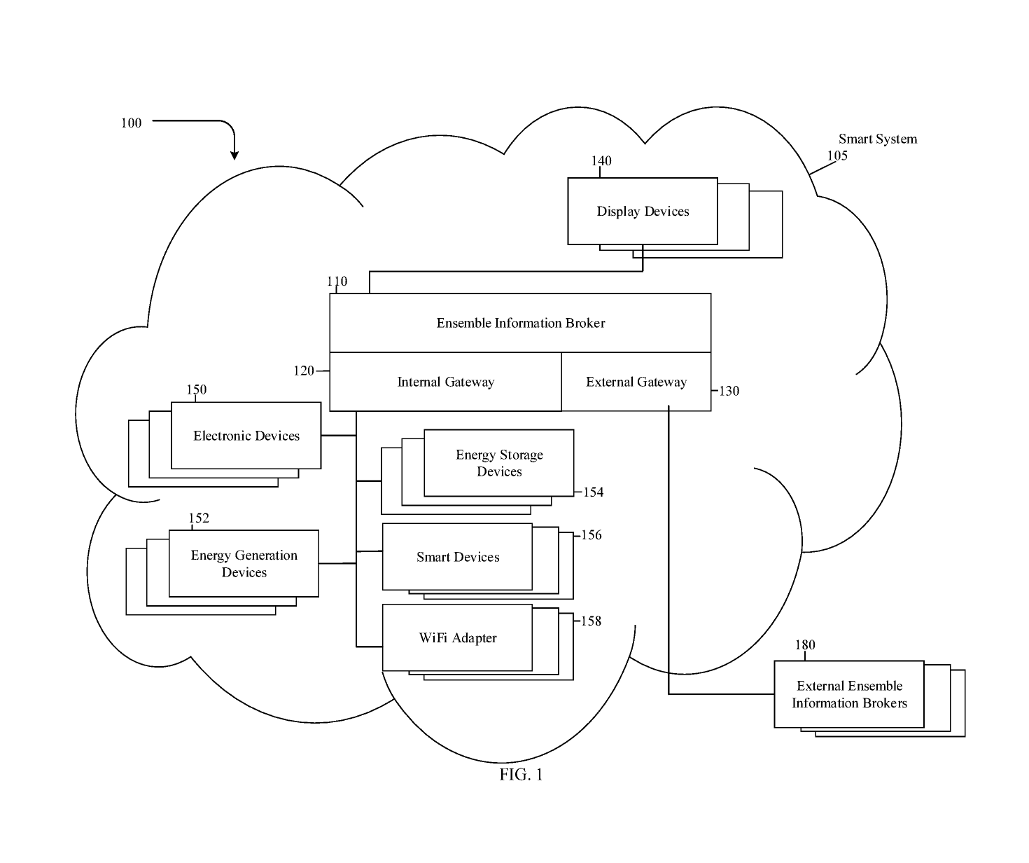

FIG. 1 is a schematic diagram of a data and energy storage internet architecture 100 comprising a smart system 105 and external EIBs 180. Smart system 105 comprises an EIB 110, multiple display devices 140, electronic devices 150, energy generation devices 152, energy storage devices 154, smart devices 156 (e.g., smart phones/tablets), and Wi-Fi adapters 158. In a disclosed embodiment, EIB 110 is associated with smart system 105 and the multiple electronic devices 150, energy generation devices 152, energy storage devices 154, smart devices 156 (e.g., smart phones/tablets), and Wi-Fi adapters 158 to provide control over the associated devices and adapters 150, 152, 154, 156, 158 and to monitor behaviors of the devices and adapters 150, 152, 154, 156, 158 as well as user interactions with the devices and adapters 150, 152, 154, 156, 158. For example, EIB 110 collects information regarding energy consumption and generation for the devices and adapters 150, 152, 154, 156, 158. In another example, EIB 110 collects information regarding a flow of energy through the devices and adapters, such as devices 140, 150, 152, 154 and 156 and Wi-Fi adapters 158, with or connected to the smart system 105. EIB 110 may collect this information, energy consumption and generation and/or the flow of energy, continuously for a specified period of time. In a disclosed embodiment, EIB 110 provides control over the associated devices and adapters 150, 152, 154, 156, 158 in order to provide energy cost efficiency and increased productivity for users interacting with devices and adapters 150, 152, 154, 156, 158 while meeting SLAs and QoS requirements established for energy storage internet architecture 100 and/or smart system 105. In a disclosed embodiment, EIB 110 communicates to the associated devices and adapters 150, 152, 154, 156, 158 though an internal network gateway 120. In an embodiment, EIB 110 is implemented on a hardware computing device. In other embodiments, EIB 110 may be implemented as a virtual layer (e.g., virtual machine) on an NE configured within a network or though commodity software integrated on an NE.

In various embodiments, internal network gateway 120 is a gateway through which the devices within smart system 105 associated with EIB 110 communicates to EIB 110. In one embodiment, internal network gateway 120 connects devices within a single network. In one embodiment, the internal network gateway 120 connects devices within multiple networks. In various embodiments, external network gateway 130 is a gateway through which devices external to smart system 105, such as external EIBs 180, connect to EIB 110.

In various embodiments, electronic devices 150 are any device that consumes energy (e.g., a personal computer, laptop). In a disclosed embodiment, the electronic devices 150 may be configured with real-time control requirements or may be configured without real-time control requirements. In various embodiments, energy generation devices 152 are any device that has the potential to generate energy (e.g., a generator). Energy generation devices 152 may be configured with constant data streaming requirements. In various embodiments, energy storage devices 154 are any device that has the potential to store energy (e.g., a battery). Energy storage devices 154 may be configured with real-time control requirements. In various embodiments, smart devices 156 are connected to other devices or networks via different wireless protocols that can operate to some extent interactively and autonomously (e.g., smart phones/tablets). In various embodiments, Wi-Fi adapters 158 are devices that add wireless connectivity to another device. In various embodiments, the devices and adapters 150, 152, 154, 156, 158 are coupled to an internal network. In other embodiments, the devices and adapters 150, 152, 154, 156, 158 are coupled to multiple internal networks.

In various embodiments, EIB 110 is any device that collects and stores energy data, human presence data, and human activity data employs the collected data to provide a set of control commands to devices and/or adapters, such as devices and adapters 150, 152, 154, 156, 158, within an associated smart system, such as smart system 105. In an embodiment, the energy data is collected from devices and adapters comprises information regarding an energy flow (e.g., energy consumption, generation, and/or storage) from devices and adapters, any data generated by the devices and adapters related to the energy flow, human activities data and/or human presence data within the associated smart system. In an example, the data generated by the devices and adapters related to the energy flow may describe the energy usage of the devices and adapters and/or a context for when energy was consumed or generated. In various embodiments, the human presence data comprises information regarding the presence of user within the smart system during a period of time or during a time interval. In various embodiments, the human activities data comprises information regarding the activities and/or interactions of users in the smart system with the devices and adapters that comprise the smart system.

In various embodiments, EIB 110 analyzes the collected data (e.g., energy, human presence, and human activity data) and provides control for the devices and adapters 150, 152, 154, 156, 158 by employing machine learning and model-based predictive control techniques to the collected data. For example, EIB 110 may control power for electronic devices 150 (e.g., whether a device is on or off) and/or a charge or discharge of energy stored on energy storage devices 154. In an embodiment, EIB 110 is configured to optimize energy costs of the controlled devices and adapters 150, 152, 154, 156, 158, and a performance of users within the smart system 105 and/or the devise and adapters through the employment of an Objective Function. The Objective Function is discussed in greater detail below.

In various embodiments, human activities data includes settings for the controlled devices and adapters 150, 152, 154, 156, 158 within the smart system 105 that a user(s) may define. In various embodiments, human presence data includes time periods and length of engagements when a user(s) interacts with for the controlled devices and adapters 150, 152, 154, 156, 158 within the smart system 105.

In various embodiments, EIB 110 is configured to improve productivity for users interacting with the controlled devices and adapters 150, 152, 154, 156, 158. EIB 110 may learn habits of users that interact with the devices and adapters 150, 152, 154, 156, 158 within the associated smart system 105 and may exchange this human presence data with other external EIBs 180 within energy storage internet architecture 100. EIB 110 may employ the human presence data gathered locally (i.e., with the assigned smart system 105 and/or received from external EIBs 180) to predict behaviors and to schedule performance and activity for the devices and adapters 150, 152, 154, 156, 158 within the associated smart system 105. Additionally, EIB 110 may detect anomalies (e.g., energy theft) by monitoring energy and data streaming within the smart system 105.

In a disclosed embodiment, EIB 110 communicates in a peer-to-peer manner to other external EIBs 180 within energy storage internet architecture 100 through an external gateway 130. In various embodiments, EIB 210 is configured within an internal network and the external EIBs 180 are configured on an external network(s). The external EIBs 180 are substantially similar to EIB 110. In various embodiments, the peer-to-peer communication between the EIB 110 and the external EIBs 180 is a decentralized communications model in which each party/node (e.g., each EIB) has the same capabilities and either party can initiate a communication session. Unlike a client/server model, in which the client makes a service request and the server fulfills the request, the peer-to-peer model allows each node to function as both a client and server. In various embodiments, EIB 110 may exchange resource information and request and send energy to the external EIBs 180. In a disclosed embodiment, EIB 110 sends and receives requests to trade information and energy resources to/from the external EIBs 180 and may establish friend connections for various EIBs from the external EIBs 180. In an embodiment, a friend connection represents mutually agreed upon a status between an EIB, such as EIB 110, and another EIB, such as external EIBs 180, within energy storage internet architecture 100.

EIB 110 may trade resources (e.g., energy) with the external EIB 180 based on a rule set(s) and/or a point-based credit scheme. In various embodiments, EIB 110 may request energy from external EIBs 180 only when EIB 110 has made a sufficient amount of contributions to the network and obtained enough points to trade the requested resources. In an embodiment, the sufficient amount of contributions to the network and/or a number of enough points to trade the requested resources is determined by a setting(s) global to the energy storage internet architecture 100. In another embodiment, the sufficient amount of contributions to the network and/or a number of enough points to trade the requested resources is determined by a setting(s) local to each EIB, such as EIB 110 and external EIBs 180, within the energy storage internet architecture 100. In an embodiment, a rule set and/or point-based system employed by EIB 110 to trade resources with the external EIBs 180 is determined based on whether an external EIB has been established as a friend connection. To state another way, one rule set and/or point-based system may be employed by EIB 110 for an external EIB that has been established as a friend connection and another rule set and/or point-based system may be employed by EIB 110 for an external EIB that has not been established as a friend connection. In an embodiment, the rules set(s) and/or point-based credit scheme enforce policies which require each EIB to contribute to the energy trading within energy storage internet architecture 100 before placing a charge (e.g., request for energy) and/or a discharge (e.g., announce that has a surplus of energy that is available for transfer) request.

EIB 110 may establish “friend” connections between each of external EIBs 180. EIB 110 may trade resources with one the external EIBs 180 based on a rule set(s) and/or a point-based credit scheme and whether a friend connection has been established. In an embodiment, the rule set(s) and point-based credit scheme enforce policies which require each EIB, such as EIB 110 and external EIBs 180, to contribute to the energy trading within energy storage internet architecture 100 before placing a discharging request. In an embodiment, the point-based credit system employed by an EIB, such as EIB 110 and external EIBs 180, assigns weighted values to external EIBs within energy storage internet architecture 100 that have sent energy to, and taken energy from, smart system 105 associated to EIB 110. The weighted values factor in the time of day that the energy was taken or received along with an amount of energy taken or received. In an embodiment, the point-based credit system employed by EIB 110 determines whether one of the external EIBs 180 is qualified to receive energy from devices, such as 150, 152, 154, 156, within the associated smart system 105 at a determined request time based on the weighted values and the amount of energy requested.

In various embodiments, EIB 110 may be coupled to multiple display devices 140. The display devices 140 may be associated with sub-networks comprising devices within the smart system 105 controlled by EIB 110. In an embodiment, display devices 140 may be an application view on a mobile device or various other display type devices. In various embodiments, the display devices 140 provide a user interface that may access and monitor the various devices and adapters 150, 152, 154, 156, 158, associated with, and controlled by EIB 110. In an embodiment, one of the display devices 140 may be configured to show reading information from EIB 110 and another of the display devices 140 may be configured to show reading information from each sub-network with the smart system 105. In various embodiments, reading information includes status of managed devices, scheduled tasks, and request status and history received from external EIBs 180. Sub-networks may comprise a subset of the devices and adapters, such as devices and adapters 150, 152, 154, 156, 158, within smart system 105.

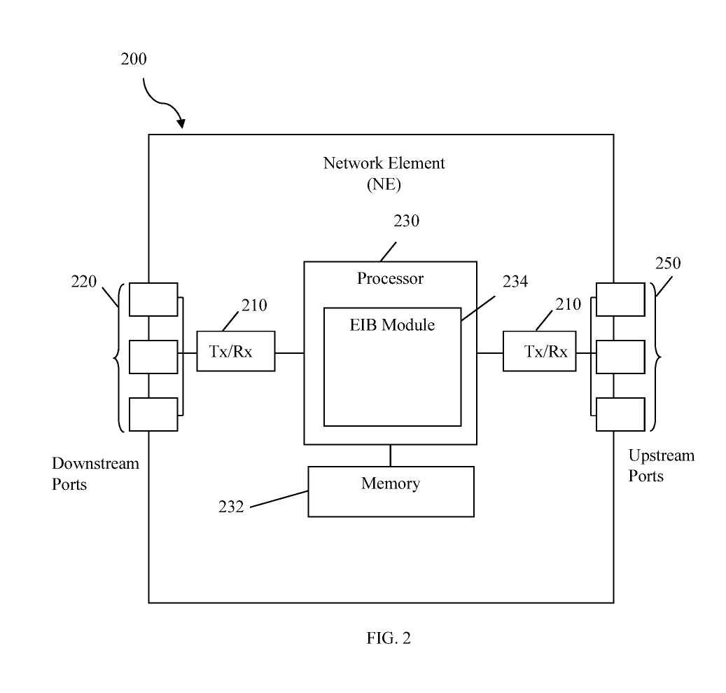

FIG. 2 is a schematic diagram of an embodiment of an NE 200 configured to implement an EIB, such as EIB 110, within a network comprising a smart system, such as smart system 105. NE 200 may be implemented in a single node or the functionality of NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments. At least some of the features/methods described in the disclosure are implemented in a network apparatus or component such as an NE 200. For instance, the features/methods in the disclosure may be implemented using hardware, firmware, and/or software installed to run on hardware. The NE 200 is any device that transports packets through a network (e.g., a switch, router, bridge, server, a client, etc).

As shown in FIG. 2, the NE 200 may comprise transceivers (Tx/Rx) 210, which are transmitters, receivers, or combinations thereof. A Tx/Rx 210 is coupled to a plurality of downstream ports 220 (e.g., downstream interfaces) for transmitting and/or receiving packets from other nodes and a Tx/Rx 210 coupled to a plurality of upstream ports 250 (e.g., upstream interfaces) for transmitting and/or receiving packets from other nodes, respectively. A processing unit 230 is coupled to the Tx/Rxs 210 to process the packets and/or determine which nodes to send packets to. The processing unit 230 may comprise one or more multi-core processors and/or memory 232 devices, which function as data stores, buffers, Random Access Memory (RAM), Read Only Memory (ROM), etc. Processing unit 230 may be implemented as a general processing unit or may be part of one or more application specific integrated circuits (ASICs) and/or digital signal processors (DSPs). Processing unit 230 comprises an EIB Module 234, which implements at least some of the methods discussed herein such as methods 500 and 600 described below. In an alternative embodiment, EIB Module 234 is implemented as instructions stored in memory 232, which are executed by processing unit 230, or implemented in part in the processing unit 230 and in part in the memory 232, for example a computer program product stored in a non-transitory memory that comprises instructions that are implemented by the processing unit 230. In another alternative embodiment, the EIB Module 234 is implemented on separate NEs. The downstream ports 220 and/or upstream ports 250 may contain electrical and/or optical transmitting and/or receiving components.

It is understood that by programming and/or loading executable instructions onto the NE 200, at least one of the processing unit 230, EIB Module 234, Tx/Rxs 210, memory 232, downstream ports 220, and/or upstream ports 250 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design is developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

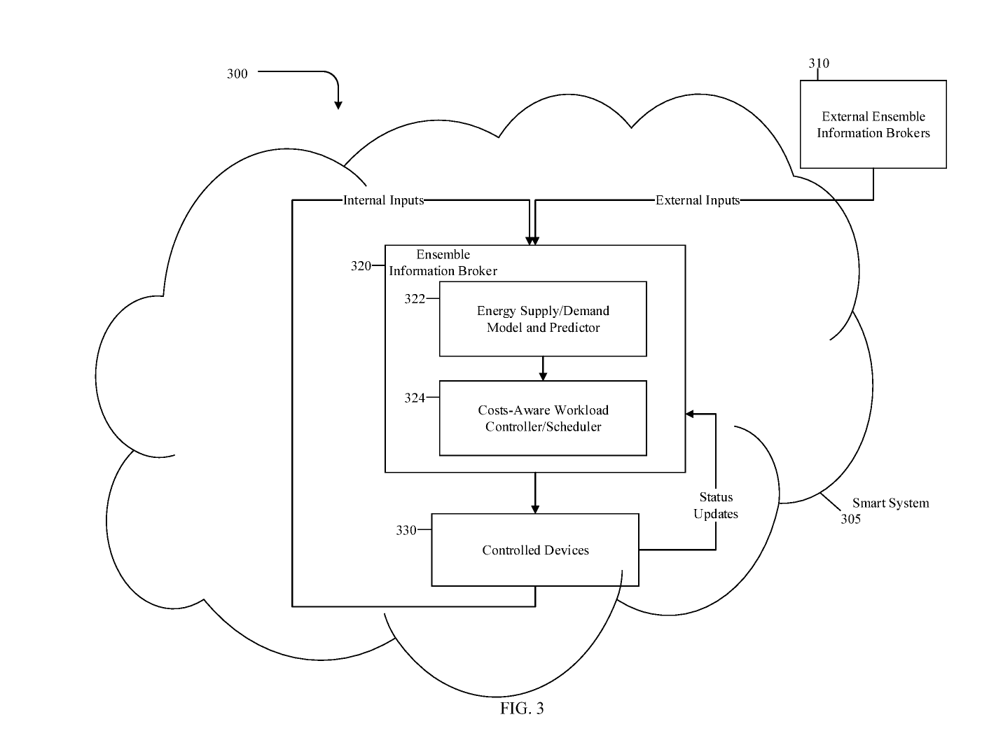

FIG. 3 is a schematic diagram of an embodiment a data and energy storage internet architecture 300 comprising a smart system 305 and external EIBs 310. Smart system 305 comprises EIB 320 and controlled devices 330. EIB 320 comprises a P Component 322 and a C Component 324. Data and energy storage internet architecture 300 is substantially similar to data and energy storage internet architecture 100. Smart system 305 is substantially similar to smart system 105. EIB 320 is substantially similar to EIB 110. External EIBs 310 are substantially similar to external EIBs 180. Controlled devices 330 are substantially similar to devices and adapters 150, 152, 154, 158.

In an embodiment, P Component 322 reads internal data inputs from the controlled devices 330 and external data inputs from external EIBs 310, updates internal system models, and sends the updated model data to C Component 324. The internal and external inputs may comprise data regarding energy usage and human activities and human presence data obtained from the various sources, such as controlled devices 330 and external EIBs 310. C Component 324 receives the updated model data and determines control function (i.e., control commands) for the controlled devices 330 within the associated smart system 305 according to optimization objectives (e.g., objective metrics) weighted through an Objective Function. An optimization objective is a pre-determined desired result to be achieved by a smart system such as reduction of cost and/or optimization of productivity.

In various embodiments, the Objective Function comprises a weighted combination of a Productivity Function and an Energy Cost Function (e.g., Cost Function), which are independent components of the Objective Function. In various embodiments, the Cost Function models an energy and/or data cost for the smart system 305 while the Productivity Function models a productivity of various users of the control devices 330 within smart system 305 and/or the control devices 330 within the smart system 305. In various embodiments, the weighted objective metrics include an operating status of the devices, a human comfort level, and a human productivity level, which are represented in the Productivity Function and an Cost Function.

In an embodiment, the Cost Function may be represented as:

Cost_function=Function(Device_Status, real-time energy price).

In an embodiment, the Productivity function may be represented as:

Productivity_Function=Function {w1*s1*Noise Function(Device Status);+w2*s2*Cool_Function(Device_Status)+w3*s3*Warm_Function(Device_Status)+w4*s4*Fresh_Function(Device_Status)+w5*s5*Humidity_Function(Device_Status)},

where w1 through w5 are based on user inputs and are set to default values if no inputs are provided; where s1 through s5 are based on human behavior analytics which are dynamically updated according to human behaviors, and where Noise_Function, Cool_Function, Warm_Function, Fresh_Function, and Humidity_Function are functions trained through the employment of existing regression methods. In an embodiment, the input of each function, such as Noise_Function, Cool_Function, Warm_Function, Fresh_Function, and/or Humidity_Function, is a device status and the output of each function is a comfort level of humans interacting with the devices a smart system associated with an EIB employing the Cost Function. The comfort level may be measures in terms of several dimensions including noise, cool, warm, air freshness, and humidity. In an embodiment, W is user input weights and S are analytics based weights. In an embodiment, the Cost Function may depend on a real-time energy price as well as a status of the devices within a smart system associated with an EIB employing the Cost Function.

In one example, an administrator of the smart system 305 may set a productivity level for the Productively Function to maintain at a minimize cost modeled through the Cost Function. In an alternative example, the administrator of the smart system 305 may set a cost level for the Cost Function to maintain for a maximum productively level modeled through the Productivity Function. In still another example, the administrator may provide a range of values for cost and productivity to be model by the Cost and Productively Function.

In various embodiments, EIB 320 may define and divide a determined period of time (e.g., twenty-four hours) into a number of time slots in order to schedule command functions for the controlled devices 330. In an embodiment, C Component 324 may send the determined control functions to the controlled devices 330 via an internal gateway, such as internal gateway 120 or may schedule a command function update for a device for a particular time slot. In another embodiment, output of the controlled device 330 may loops back as internal input to EIB 320 thus creating a feedback loop. The feedback loop allows P Component 322 and C Component 324 to fine tune the internal system models to provide a more optimal low cost and/or high productivity level depending on a set of system parameters for the EIB 320 and/or smart system 305. In an embodiment, an administration user may set the system parameters for the EIB 320 and/or smart system 305.

In various embodiments, P Component 322 and C Component 324 may be implemented in a network apparatus or module such as, for example, NE 200, a personal computer (PC), and/or a mobile device (e.g., smart phone, tablet computer, etc.). The features and/or methods implemented by EIB 320 may be realized using hardware, firmware, and/or software installed on the network apparatus or module. P Component 322 and C Component 324 are described in greater detail in other figures below.

Various data inputs may be received by EIB 320 from internal sources (i.e., sources within smart system 305), such as controlled devices 330, and external sources (i.e., sources not within smart system 305), such as external EIBs 310. Examples of data inputs include data sources and system requirements comprising renewable energy supply, energy storage status, data streaming SLAs, energy consumption data, renewable energy, weather information, and owner's QoS requirements. Data inputs may also include commands from user interface displayed on, for example, a display, such as displays 140, or a smart device, such as smart devices 156. Data inputs may also include measured human activity for the controlled devices within an associated smart system and/or calendar data associated with the controlled devices. Data inputs may include data received from internet data consumption devices and energy consumption devices. Data inputs may also include updated prices information.

The data inputs received from the controlled devices 330 and the external EIBs 310 feed into P Component 322 as data points. P Component 322 processes and models the various supplied data points and feeds the results into C Component 324. C Component 324 determines control functions for the controlled devices within an associated smart system based on the modeled data and feeds the decisions (e.g., control parameters) into the various controlled devices 330, such as electric devices 150, energy generation devices 152, and energy storage devices 154, controlled by EIB 320. For example, EIB 320 may receive a command internal inputs (e.g. from a user interface) and may forward a received command to P Component 322 which may then forward the results of the command and model date to C Component 324. In other embodiments, EIB 320 may forward the command directly to C Component 324. C Component 324 processes the received data (e.g., the command or the model results) and may then send a control signal to a corresponding device to alter or change a behavior on the devices or to direct energy away from or toward the particular device. In various embodiments, the controlled devices feed status updates to C Component 324. C Component 324 may use the status updates to employ this data when determining the various command functions to send to the controlled devices 330.

In one example, EIB 320 may receive a command from the user interface for an electronic device M with no real-time control requirements, such as electronic devices 150, to activate a control decision variable associated with the electronic device M. For example, a specific control may be powering on or powering off the device, sending stored or generated energy to a destination, or scheduling increased power consumption on the device for an amount of time. The command is forwarded by EIB 320 to the C Component 324 where a control decision variable associated with the electronic device M is activated. C Component 324 then sends a corresponding control command to the electronic device M corresponding to the activated control decision variable. In various embodiments, a control decision various for a device, such as those include in controlled devices 330, is mapped to a specific control on the device. Control decision variable may be established for each controlled device 330 within smart system 305. Thus, EIB 320 may control the various mapped functions on the controlled devices though the manipulation of the mapped control decision variables.

In another example, EIB 320 may receive a command from the user interface for an electronic device N with real-time control requirements, such as electronic devices 150, to update a model associated with the electronic device N and to activate a control decision variable associated with the electronic device N. The command is forwarded by EIB 320 to P Component 322 where the model associated with the electronic device N is updated and the results forwarded to C Component 324. C Component 324 then activates a control decision variable associated with the electronic device N. C Component 324 then sends a corresponding control command to the electronic device N corresponding to the activated control decision variable. The command from the proceeding example may also be employed for an Energy Generation device, such as Energy Generation Devices 152, or an Energy Storage device, such as Energy Storage Devices 154.

In yet another example, EIB 320 may receive a command from the user interface to update a monitored human activity. The command is forwarded by EIB 320 to C Component 324 where the Cost Function and constraint(s) associated with the monitored human activity is updated. C Component 324 may then send a control command to any devices affected by the updated Cost Function and/or constraint(s).

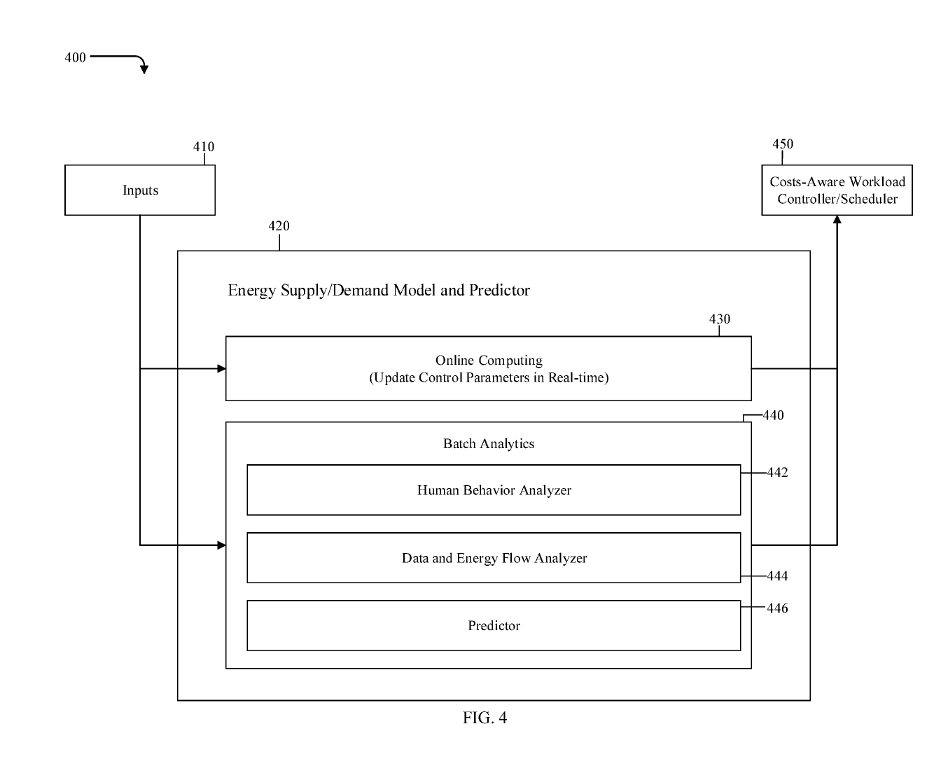

FIG. 4 a schematic diagram of an embodiment 400 of a P component 420 implemented on an EIB, such as EIB 110 and 310 and NE 200. In an embodiment, P Component 420 continuously checks for a command or data from data from inputs 410. Inputs 410 may be received from internal sources, such as Controlled Devices 330, and/or from external sources, such as External EIBs 310. P Component 420 is substantially similar to P Component 322. P 420 comprises an Online Computing Component 430 and a Batch Analytics Component 440. The Batch Analytics Component 440 comprises a Human Behavior Analyzer Component 442, a Data and Energy Flow Analyzer Component 444, and a Predictor Component 446. In an embodiment, Online Computing Component 430 updates the control parameters in real-time associated with models for the devices, such as devices and adapters 150, 152, 154, 156, 158, controlled by the EIB and sends the results to a C Component 450. C Component 450 is substantially similar to C Component 324.

The components comprising the Batch Analytics Component 440, Human Behavior Analyzer Component 442, Data and Energy Flow Analyzer Component 444, and Predictor Component 446, collect data received from the inputs 410 and perform calculations on various models and apply analytics to the various models for a defined period of time. The results of the calculation are sent to the C Component 450 at a determined interval.

In an embodiment, the Human Behavior Analyzer Component 442 collects human activities data regarding human interaction with the various devices controlled by the EIB during a time slot and human presence data regarding a presence of a user(s) within the smart system during a time slot. The collected human activities data may include a time of day and number of hours a user interacts with a particular device(s) and/or a combination of device(s) interacted with during a particular time slot. Human activities data may comprise input data received directly from the user by the devices within the smart system; application data from a smart device, such as smart devices 156; user calendar data, and application data and/or data readings from Internet device, such as electronic devices 150. The Human Behavior Analyzer Component 442 may determine a temporal human behavior(s) for a user of the smart system based an analysis of the human activities data and the human presence data. The temporal human behaviors may include any predicted future activity or interaction by the user with the devices within the smart system. Such behaviors may include a predicted timeframe where the user may interact with a device within the smart system, a predicted use of Internet or wireless resources by the user, a number of simultaneous devices employed by the user at a particular timeframe, etc. In various embodiments, the Human Behavior Analyzer Component 442 may determine a temporal human behavior(s) based on a priorities analysis of the various human activities data. For example, a pre-defined priority mechanism may set a first priority level for data inputted directly by the user, a second priority level for calendar data, and a third priority level for data readings from Internet providing devices. In an embodiment, the temporal human behavior(s) are determined from an available data group or set with highest priority. In this embodiment, if no data if available from one group or set, the Human Behavior Analyzer Component 442 may look for data from the next highest priority group to determine the temporal human behavior(s).

In an embodiment, the Data and Energy Flow Analyzer Component 444, collects data regarding the flow of energy and data through the various devices controlled by the EIB as well as the amount of energy consumed and/or generated by a device(s) for a particular period of time. In an embodiment the Data and Energy Flow Analyzer Component 444 may examine a maximum energy over data consumption ratio based on time theory data over a determined period of time and send alerts to user and received response from user based on an adaptive threshold mechanism, which is employed to determine whether the energy over data consumption ratio exceeds an adaptive threshold. In an embodiment, time theory data is a sequence of data points including successive measurements made over a time interval.

In an embodiment, the Predictor Component 446 leverages prediction algorithms to estimate the future affairs of difference categories of information, including energy storage, consumption, and/or generation within an associated smart system, such as smart system 105 and 305, and may analyze the energy consumption and generation of various inputs. The Predictor Component may determine a future energy metric for the smart system during a future time slot based on a difference between the future energy consumption and the future energy generation of the smart system during the future time slot

Further, the Predictor Component 446 updates a charge model for the devices within an associated smart system. In one example, a charge model may be set to “x̂(t+1)=xt+ut−qt” where x is an inventory level of an energy storage device (e.g. battery), t is a specific time, xt is an inventory level of an energy storage device (e.g. battery) at the time t, ut is an amount of energy charged to the energy storage device at the time t, and qt is the amount of energy discharged from the energy storage device at the time t. The predictor may update the charge model according to the inputs of SLAs, QoSs, energy storage status, and renewable energy supply.

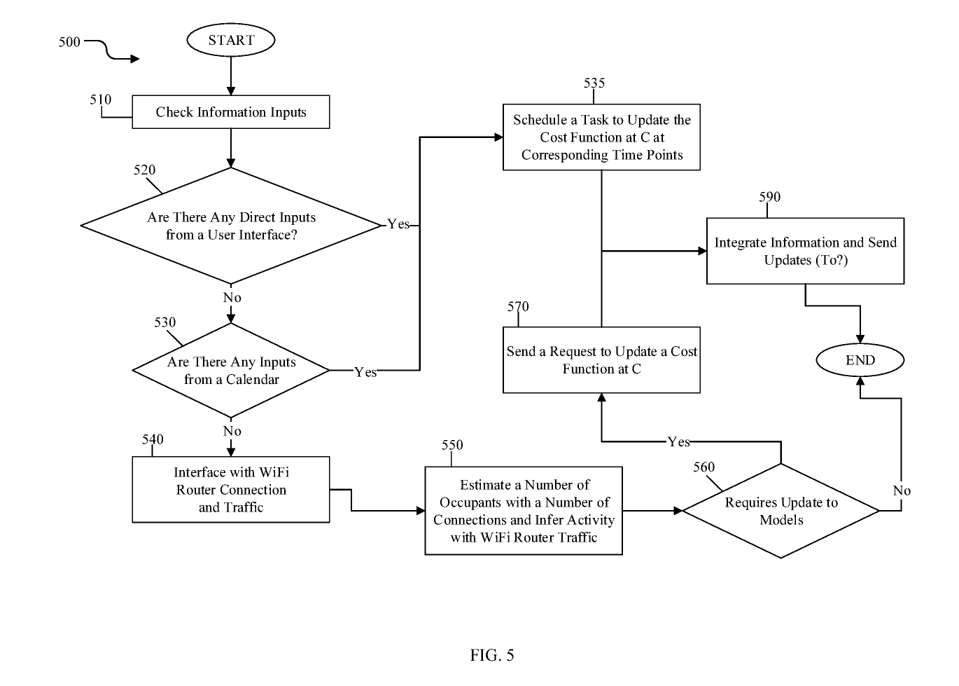

FIG. 5 is a flowchart of an embodiment of a method 500 that is implemented in a Human Behavior Analyzer Component, such as Human Behavior Analyzer Component 442, of an EIB, such as EIB 110 and 320 and NE 200, when an input is received by the Human Behavior Analyzer Component. At step 510, the Human Behavior Analyzer Component checks the information inputs from various internal sources, such as controlled devices 330, and external sources, such as external EIBs 310. At decision step 520, the Human Behavior Analyzer Component moves to step 535 if there are direct inputs from a user interface shown via displays, such as displays 140 or smart devices, such as smart devices 156. At decision step 520, the Human Behavior Analyzer Component moves to step 530 if there are no direct inputs from the user interface. At decision step 530, the Human Behavior Analyzer Component moves to step 535 if there are inputs from a calendar associated with a user(s) that may interact with the controlled devices within an associated smart system. At decision step 530, the Human Behavior Analyzer Component moves to step 540 if there are no inputs from the calendar. At step 535, the Human Behavior Analyzer Component, schedules a task to update a Cost Function managed by the C Component, such as C Components 450 and 324, at time points corresponding to time inputs received via the user interface or read from the calendar and moves to step 590. At step 540, the Human Behavior Analyzer Component interfaces with the Wi-Fi Router Connection and reads the current traffic. At step 550, the Human Behavior Analyzer Component estimates a number of occupants using an associated smart system, such as smart system 105 and 305, based on a number of connections to the Wi-Fi and infers activity based on the Wi-Fi Router Traffic. At decision step 560, the Human Behavior Analyzer Component proceeds to step 570 if the inferred activity requires an update to the behavior models associated with the human behavior observed within the smart system. At step 570, the Human Behavior Analyzer Component sends a request the C Component to update a cost Function based on the updates to the human behavior models and moves to step 590. At step 590, the Human Behavior Analyzer Component integrates the received information into behavior models associated with the smart system and sends updates to the C Component.

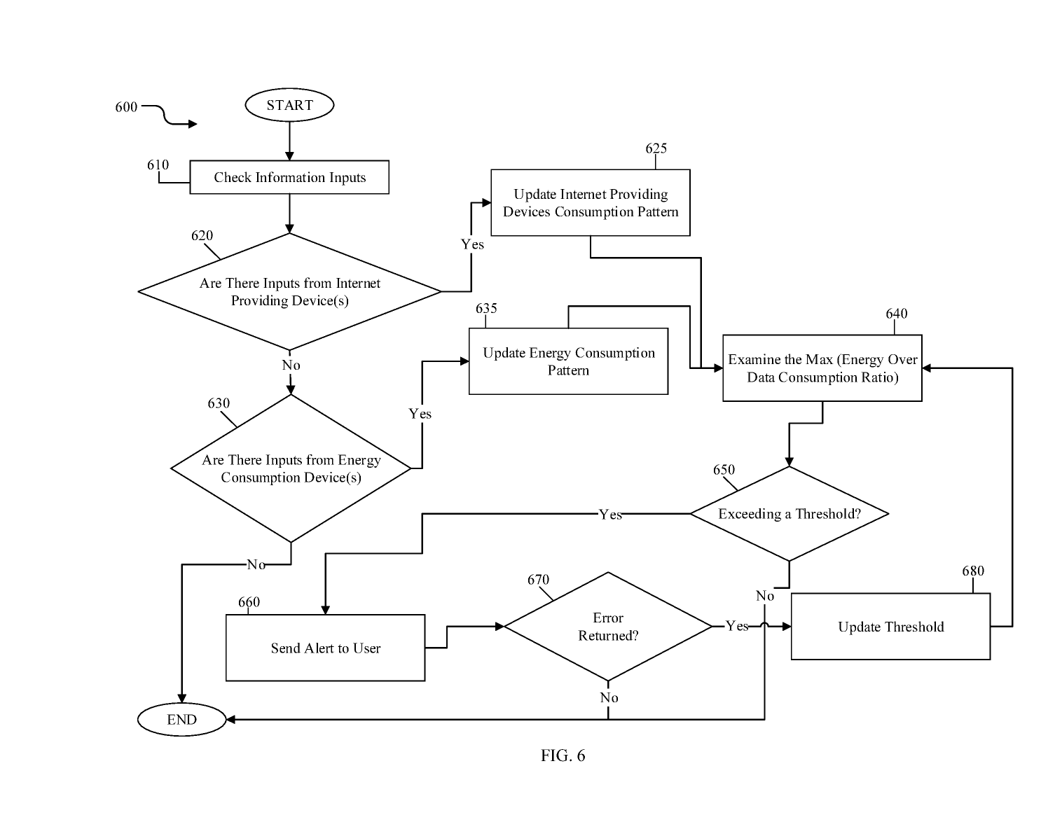

FIG. 6 is a flowchart of an embodiment of a method 600 that is implemented in a Data and Energy Flow Analyzer Component, such as Data and Energy Flow Analyzer Component 444, of an EIB, such as EIB 110 and 320 and NE 200, when an input is received by the Data and Energy Flow Analyzer Component. At step 610, the Data and Energy Flow Analyzer Component checks the information inputs from various internal sources, such as Controlled Devices 330, and external sources, such as external EIBs 180 and 310. At decision step 620, the Data and Energy Flow Analyzer Component proceeds to step 625 when inputs are received from devices, such as energy devices 150, that provide Internet service (e.g., a modem). At decision step 620, the Data and Energy Flow Analyzer Component proceeds to decision step 630 if there are no inputs from the Internet providing devices. At step 625, the Data and Energy Flow Analyzer Component updates an Internet providing devices consumption pattern with the received inputs and proceeds to step 640. In various embodiments, the Internet providing devices consumption pattern is an internal model that contains historical data regarding the energy consumed and data generated regarding the energy consumed from the Internet providing devices within an associated smart system. In various embodiments, the Internet providing devices consumption pattern may be employed to determine activities of users of an associated smart system. At decision step 630, the Data and Energy Flow Analyzer Component ends the process if there are no inputs from the Internet providing devices. At decision step 630, the Data and Energy Flow Analyzer Component proceeds to step 635 if there are inputs from energy consumption devices. At step 635, the Data and Energy Flow Analyzer updates the Energy Consumption pattern with the received inputs and proceeds to step 640. In various embodiments, the energy data consumption pattern is an internal model that contains historical data regarding the energy consumed and data generated regarding the energy consumed by the devices within an associated smart system. In various embodiments, the energy data consumption pattern may be employed to determine activities of the energy consumption devices within an associated smart system. At step 640, the Data and Energy Flow Analyzer Component examines a maximum energy over data consumption ratio based on a time theory data over a determined period. In various embodiments, the data consumption ratio is employed to correlate the activity of the energy consumption devices and activities of users of an associated smart system and as a metric to evaluate a status of the energy consumption devices. At decision step 650, the Data and Energy Flow Analyzer Component proceeds to step 660 if the energy over data consumption ratio exceeds an adaptive threshold. In an embodiment, the ratio is set by a command received via a user interface displayed on a display, such as displays 140, and/or a smart device, such as smart devices 156. At decision step 650, the Data and Energy Flow Analyzer Component ends the process if the energy over data consumption ratio does not exceed the adaptive threshold. At step 660, the Data and Energy Flow Analyzer Component sends an alert to a user interface displayed on a display, such as displays 140, and/or a smart device, such as smart devices 156 that the energy over data consumption ratio has exceeded the adaptive threshold. At decision step 670, the Data and Energy Flow Analyzer Component proceed to step 680 if the user interface returns an error. At decision step 670, the Data and Energy Flow Analyzer Component ends the process if no error is returned by the user interface. At step 680, the Data and Energy Flow Analyzer Component updates the adaptive threshold if the user interface returns an error and proceeds to step 640.

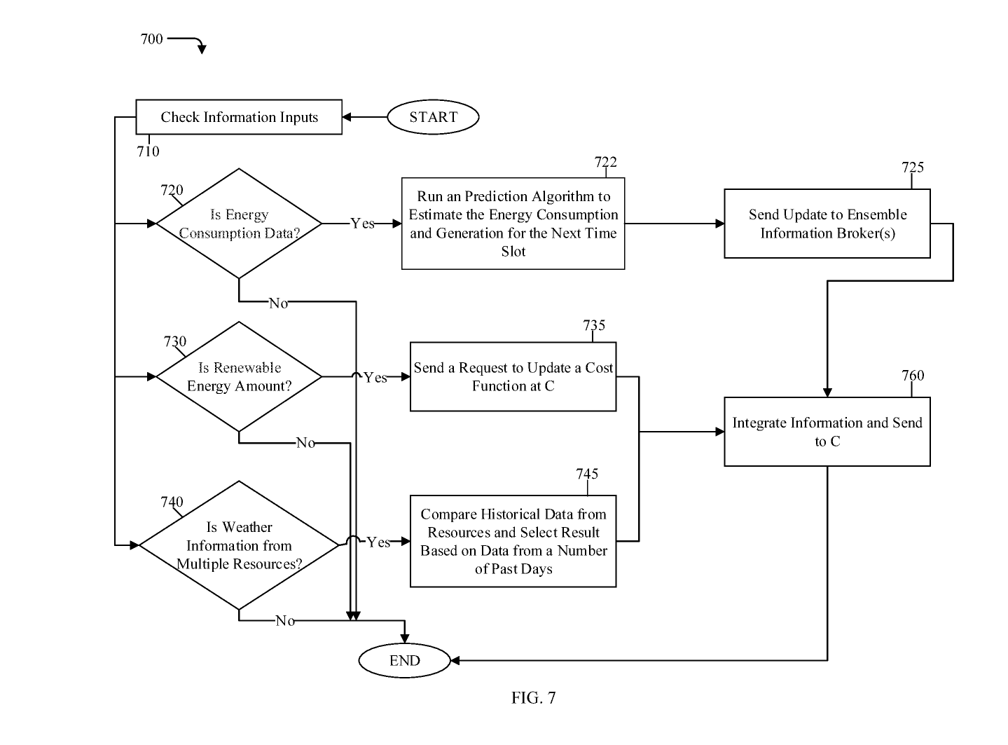

FIG. 7 is a flowchart of an embodiment of a method 700 that is implemented by a Predictor Component, such as Predictor Component 446, of an EIB, such as EIB 110 and 320 and NE 200, when an input is received by the Predictor Component. At step 710, the Predictor Component checks the information inputs from various internal sources, such as Controlled Devices 330, and external sources, such as external EIBs 310, and proceeds to decision step 720, decision step 730, and decision step 740. At decision step 720, the process ends if the input data is not energy consumption data. At decision step 720, the Predictor Component proceeds to step 722 if the input data is energy consumption data. At step 722, the Predictor Component preforms a Prediction Algorithm to estimate the energy consumption and/or generation for a future time slot. In various embodiments, the Prediction Algorithm may be a regression based and linear or non-linear. The Predictor Component may determine a future energy metric for the smart system during the next time slot based on a difference between the future energy consumption and the future energy generation of the smart system during the future time slot. The Predictor Component may then proceeds to step 725. At step 725, the Predictor Component sends updates determined by the Prediction Algorithm to external EIB(s), such as External EIBs 180, connected to the EIB through an external gateway, such as External Gateway 130 and proceeds to step 760. At decision step 730, the process ends if the data inputs are a not renewable energy amount. At decision step 730, the Predictor Component proceeds to step 735 when the data inputs are a renewable energy amount. At step 735, the Predictor Component sends a request to a C Component, such as C Components 450 and 324, to update a Cost Function and proceeds to step 760. At decision step 740, the process ends if the data inputs do not contain weather information. At decision step 740, the Predictor Component proceeds to step 745 if the data inputs contain weather information. At step 745, the Predictor Component compares historical data from resources in an associated smart system and predicts a future value for energy consumption and/or generation within the associated smart system and for various devices within the associated smart system based on data from a number of past days from the historical data and current weather data. The Predictor Component then proceeds to step 760. At step 760, the Predictor Component integrates the received information and sends the updated data model data to the C Component and ends.

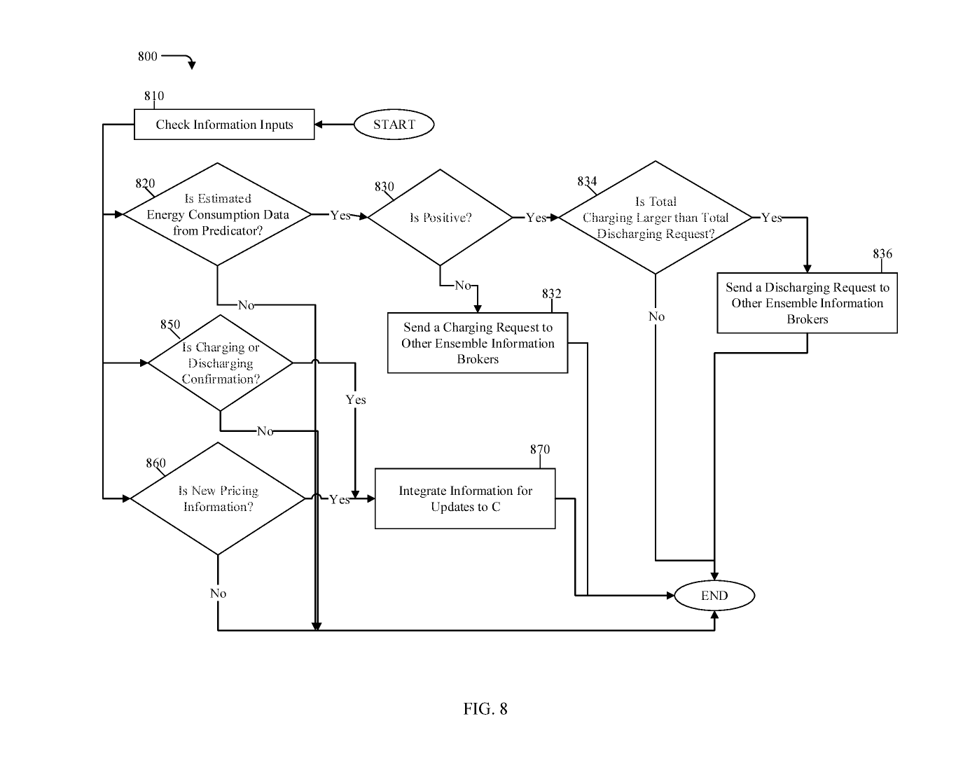

FIG. 8 is a flowchart of an embodiment of a method 800 that is implemented on an EIB, such as EIB 110 and 320 and NE 200, when input data is received or sent to an external EIB, such as External EIBs 180, connected to the EIB through an external gateway, such as External Gateway 130, within an energy storage internet architecture, such as energy storage internet architecture 100. At step 810, the EIB checks the information inputs from various internal sources, such as controlled devices 330, and external sources, such as external EIBs 180 and 310, and proceeds to decision step 820, decision step 830, and decision step 840. At decision step 820, the process ends if the data input is not estimated energy consumption data received from a Predictor Component, such as Predictor Component 446. At decision step 820, the EIB proceeds to decision step 830 if the data input is estimated energy consumption data received from a Predictor Component, such as Predictor Component 446. At decision step 830, the EIB proceeds to step 832 if the estimated energy consumption data received from the Predictor Component is negative. At decision step 830, the EIB proceeds to decision step 834 if the estimated energy consumption data received from the Predictor Component is positive. At step 832, the EIB sends a charging request to the external EIBs because the energy consumption of an associated device is negative (e.g., the device is consuming more power than it is receiving and/or producing). At decision step 834, the EIB proceeds to step 836 if a total charging request is larger than a total discharging request for the associated smart system (e.g., the smarty system has a surplus of energy). At step 836, the EIB sends a discharging request to the external EIBs. At decision step 850, the process ends if the data inputs are a not a charging or a discharging confirmation. At decision step 850, the EIB proceeds to step 870 if the data inputs are a charging or a discharging confirmation. At decision step 860, the process ends if the data inputs are not for new pricing information. At decision step 860, the EIB proceeds to step 870 if the data inputs are for new pricing information. At step 870, the EIB integrates the charging or discharging confirmation and/or the new pricing information for updates to a C Component, such as C Components 450 and 324.

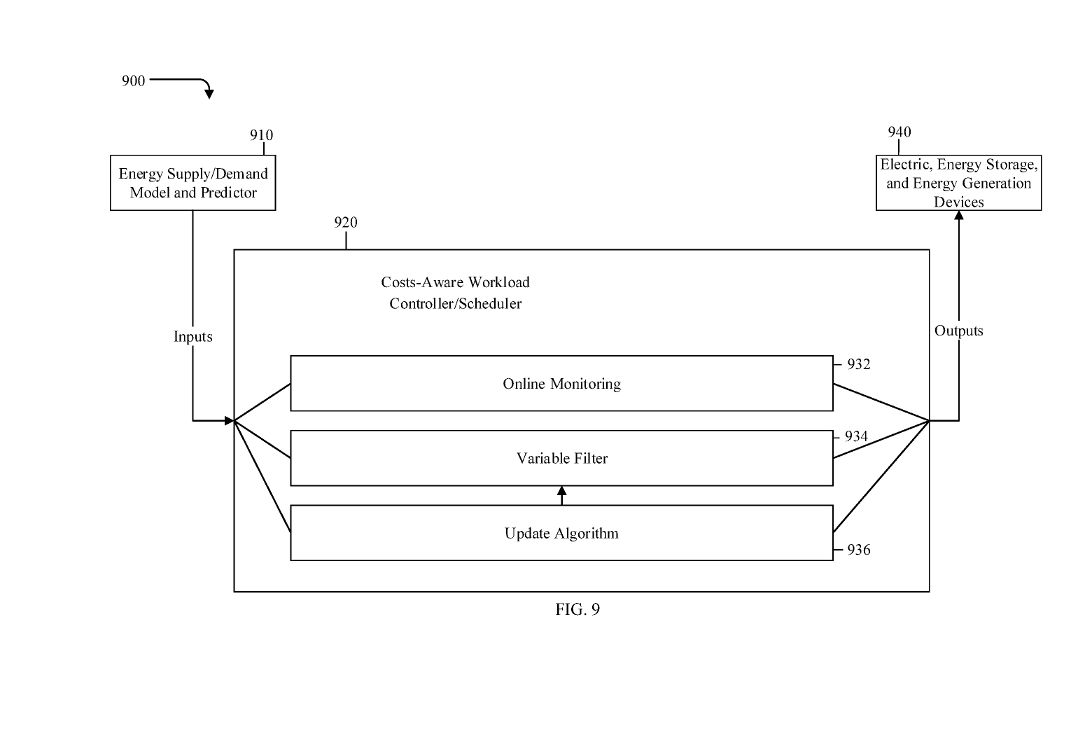

FIG. 9 a schematic diagram of an embodiment 900 of a C Component 920 implemented on an EIB, such as EIB 110 and 320 and NE 200. C Component 920 is substantially similar to C Component 324. C Component 920 comprises Online Monitoring Component 932, Variable Filter 934, and Update Algorithm Component 936, which are employed to recursively update cost and state functions that comprise an Objective Function associated with the smart system, such as smart system 105 and 305, controlled by the EIB. In various embodiments, Online Monitoring Component 932 monitors system dynamics and user inputs updates, Variable Filter 934 selects coefficients for an adaptive filter(s), and Update Algorithm Component 936 updates the adaptive filter(s) as new data arrives. C Component 920 receives inputs from P Component 910 and sends outputs to Electric, Energy Storage, and Energy Generation Devices 940 controlled by the EIB. P Component 910 is substantially similar to P Component 322. Electric, Energy Storage, and Energy Generation Devices 940 are substantially similar to electronic devices 150, energy storage devices 154, and energy generation devices 152. In various embodiments, C Component 920 generates outputs, such as an alert and control commands for the Electric, Energy Storage, and Energy Generation Devices 940, a pattern detection method. The pattern detection method monitors the energy and data streaming pattern and reports an alert to an assigned recipient when a maximum of energy over data ratio exceeds a threshold indicating an anomaly, such as an energy theft, occurs.

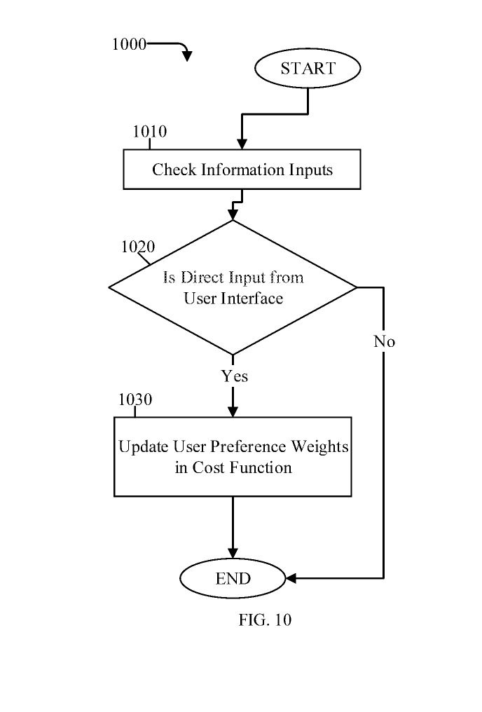

FIG. 10 is a flowchart of an embodiment of a method 1000 that is implemented on an EIB, such as EIB 110 and 320 and NE 200, when input data is received from a user interface. At step 1010, the EIB checks the information inputs from various internal sources, such as controlled devices 330, and external sources, such as external EIBs 180 and 310. At decision step 1020, the EIB proceeds to step 1030 if the inputs are Direct Inputs from a User Interface displayed on, for example, a display, such as displays 140, or a smart device, such as smart devices 156. At step 1030, the EIB updates the Cost Function associates with the associated smart system with the inputs. In an embodiment, the updates to the Cost Function may include user preferences, which are coefficients or implied coefficients in the Cost Function.

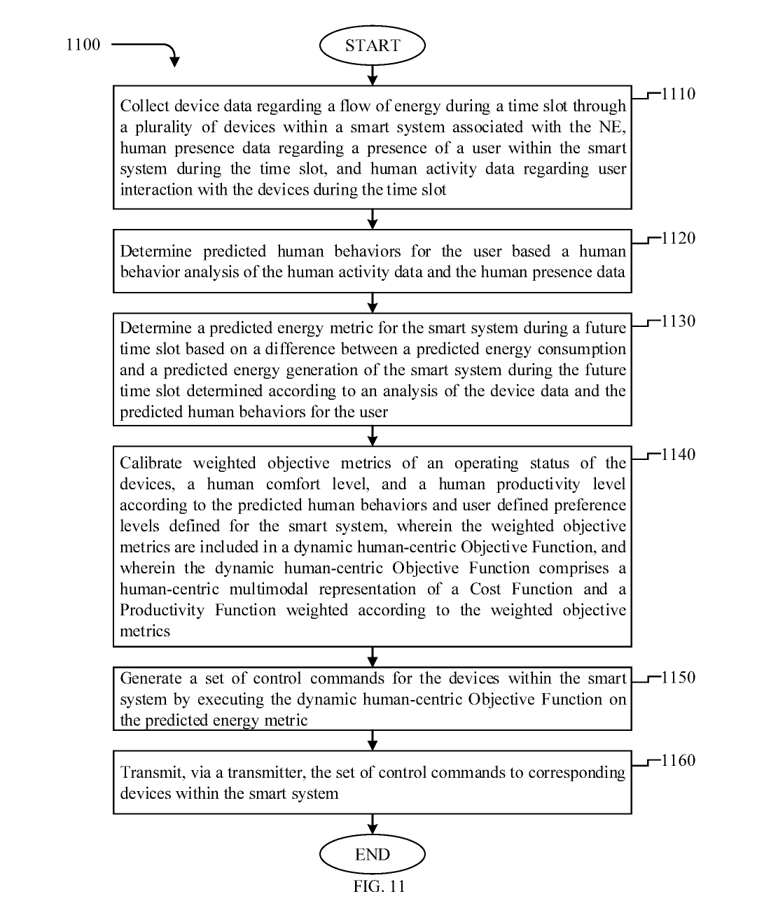

FIG. 11 is a flowchart of an exemplary embodiment of a method 1100 employed by an EIB, such as EIBs 110 and 180 and NE 200, and that is implemented within a data and energy storage internet architecture, such as energy storage internet architectures 100 and 300, to collect energy data and human presence and to generate a set of control commands for devices within an associated smart system EIB through a prediction of future energy consumption requirements and energy generation of the devices within the associated smart system. At step 1110, the EIB collects device data regarding a flow of energy during a time slot through a plurality of devices within a smart system associated with the NE, human presence data regarding a presence of a user within the smart system during the time slot, and human activity data regarding user interaction with the devices during the time slot. At step 1120, the EIB determines predicted human behaviors for the user based a human behavior analysis of the human activities data and the human presence data. At step 1130, the EIB determines a predicted energy metric for the smart system during a future time slot based on a difference between a predicted energy consumption and a predicted energy generation of the smart system during the future time slot determined according to an analysis of the device data and the predicted human behaviors for the user. At step 1140, the EIB calibrates weighted objective metrics of an operating status of the devices, |a human comfort level, and a human productivity level according to the predicted human behaviors and user defined preference levels defined for the smart system, wherein the weighted objective metrics are included in a dynamic human-centric Objective Function, and wherein the dynamic human-centric Objective Function comprises a human-centric multimodal representation of a Cost Function and a Productivity Function weighted according to the weighted objective metrics. At step 1150, the EIB generates a set of control commands for the devices within the smart system by executing the dynamic human-centric Objective Function on the predicted energy metric. At step 1160, the EIB transmits, via a transmitter, the set of control commands to corresponding devices within the smart system.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A network element (NE) configured to operate as an Ensemble Information Broker (EIB) within a distributed data and energy storage internet architecture, the NE comprising:
a receiver configured to:
collect device data regarding a flow of energy during a time slot through a plurality of devices within a smart system associated with the NE;
collect a presence of a user within the smart system during the time slot as human presence data; and
collect human activity data regarding user inputs to the devices and user interaction with the devices during the time slot;
a processor coupled to the receiver and configured to:
preform a human behavior analysis of the human activity data and the human presence data to determine temporal human behaviors for the user;
determine a projected energy consumption and a projected energy generation for the devices during a future time slot based on the device data and the temporal human behaviors for the user;
determine a projected energy metric for the smart system during the future time slot based on a difference between the projected energy consumption and the projected energy generation of the smart system during the future time slot;
calibrate weighted objective metrics of an operating status of the devices, a human comfort level, and a human productivity level according to the temporal human behaviors and user defined preference levels defined for the smart system, wherein the weighted objective metrics are included in a dynamic human-centric Objective Function;
execute the dynamic human-centric Objective Function on the projected energy metric to generated a result; and
generate a set of control commands for the future time slot for the devices according to the result; and
a transmitter coupled to the processor and configured to transmit the set of control commands to corresponding devices within the smart system.

2. The NE of claim 1, wherein the dynamic human-centric Objective Function comprises a human-centric multimodal representation of a weighted sum of an energy Cost Function and a user Productivity Function, wherein the energy Cost Function is a representation of an operating status of the devices, and wherein the user Productivity Function is a representation of a human comfort level and a human productivity level within the smart system and comprises a noise function, a cool function, a warm function, a fresh function, and a humidity function each regarding a corresponding operating status of the devices.

3. The NE of claim 1, wherein the control commands are for future configuration updates to the devices.

4. The NE of claim 1, wherein the processor is further configured to generate a request for energy resource when the projected energy metric indicates a shortage of energy for the smart system during the future time slot, and where the transmitter is further configured to transmit the request to an external NE configured to operate as an external EIB in the distributed data and energy storage internet architecture.

5. The NE of claim 1, wherein the processor is further configured to generate a message indicating a surplus of energy when the projected energy metric indicates a surplus of energy for the smart system during the future time slot, and where the transmitter is further configured to transmit the message to an external NE configured to operate as an external EIB in the distributed data and energy storage internet architecture.

6. The NE of claim 1, wherein the processor is further configured to generate an alert when a maximum of a data to energy consumption ratio exceeds a threshold based on an adaptive threshold mechanism.

7. The NE of claim 6, wherein the receiver is further configured to receive a request to update the threshold based on the alert, wherein the processor is further configured to update the threshold to a current maximum of data to energy consumption ratio.

8. The NE of claim 1, wherein the device data includes an amount of energy consumed by the devices during the time slot and an amount of energy generated by the devices during the time slot.

9. The NE of claim 1, wherein the dynamic human-centric Objective Function provides a mechanism for a reduction of energy cost within the smart system and an optimization of a productivity of user devices that interact with the smart system.

10. The NE of claim 1, wherein the weighted objective metrics are updated by weighting the Objective Function according to user preferences received from a user interface coupled to the NE and within the smart system.

11. A computer program product comprising computer executable instructions stored on a non-transitory computer readable medium such that when executed by a processor cause a network element (NE) configured to operate as an Ensemble Information Broker (EIB) within a distributed data and energy storage internet architecture to:
collect device data regarding a flow of energy during a time slot through a plurality of devices within a smart system associated with the NE and data generated by the devices related to the flow of energy during the time slot, human presence data regarding a presence of a user within the smart system during the time slot; and human activity data regarding user interaction with the devices during the time slot;
determine predicted human behaviors for the user based a human behavior analysis of the human activity data and the human presence data;
update an energy data consumption pattern with the device data, wherein the energy data consumption pattern is an internal model that contains historical data regarding an amount of energy consumed and data generated regarding the energy consumed by the devices;
determine a predicted energy consumption and a predicted energy generation of the smart system during a future time slot through an application of a charge model associated with the devices to the energy data consumption pattern and the predicted human behaviors;
determine a predicted energy metric for the smart system during the future time slot based on a difference between the predicted energy consumption and the predicted energy generation of the smart system during the future time slot;
generate a request for energy resources during the future time slot when the predicted energy metric indicates a shortage of energy for the smart system during the future time slot; and
transmit, via a transmitter, the request to an external NE configured to operate as an external EIB in the distributed data and energy storage internet architecture.

12. The computer program product of claim 11, wherein the charge model is represented as x̂(t+1)=xt+ut−qt, wherein xt is an inventory level of an energy storage device at a time t, ut is an amount of energy charged to the energy storage device at the time t, and qt is an amount of energy discharged from the energy storage device at the time t, wherein the energy storage device is included in the plurality of devices within the smart system.

13. The computer program product of claim 11, further comprising sending an alert to a user interface when a maximum value for a data consumption ratio exceeds a threshold, wherein the data consumption ratio is determined based on an Internet providing devices consumption pattern.

14. The computer program product of claim 11, wherein the human presence data comprise information contained in a calendar associated with a user that interacts with the devices within the smart system.

15. The computer program product of claim 11, wherein the human presence data comprise information indicating an estimated number of connections to a Wi-Fi device within the smart system at given time.

16. A method implemented in a network element (NE) configured to operate as an Ensemble Information Broker (EIB) within a data and energy storage internet architecture, the method comprising:
collecting device data regarding a flow of energy during a time slot through a plurality of devices within a smart system associated with the NE, human presence data regarding a presence of a user within the smart system during the time slot, and human activity data regarding user interaction with the devices during the time slot;
determining predicted human behaviors for the user based on a human behavior analysis of the human activity data and the human presence data;
determining a predicted energy metric for the smart system during a future time slot based on a difference between a predicted energy consumption and a predicted energy generation of the smart system during the future time slot determined according to an analysis of the device data and the predicted human behaviors for the user;
calibrating weighted objective metrics of an operating status of the devices, a human comfort level, and a human productivity level according to the predicted human behaviors and user defined preference levels defined for the smart system, wherein the weighted objective metrics are included in a dynamic human-centric Objective Function, and wherein the dynamic human-centric Objective Function comprises a human-centric multimodal representation of a Cost Function and a Productivity Function weighted according to the weighted objective metrics;
generating a set of control commands for the devices within the smart system by executing the dynamic human-centric Objective Function on the predicted energy metric; and
transmitting, via a transmitter, the set of control commands to corresponding devices within the smart system.

17. The method of claim 16, wherein the Cost Function is a representation of an operating status of the devices, and wherein the weighted Productivity Function is a representation of a human comfort level and a human productivity level within the smart system.

18. The method of claim 17, wherein the dynamic human-centric Objective Function provides a mechanism for a reduction of energy cost within the smart system and an optimization of a productivity of user devices that interact with the smart system.

19. The method of claim 16, further comprising sending a charge request to external NEs configured to operate as EIBs within the data and energy storage internet architecture when the predicted energy metric indicates a need for energy for the smart system.

20. The method of claim 16, further comprising sending a discharge request to external NEs configured to operate as EIBs within the data and energy storage internet architecture when the predicted energy metric indicates a surplus of energy for the smart system.
